(19) United States
(12) Patent Application Publication
(10) Pub. No.: US 2026/0298298 A1
(43) Pub. Date: Oct. 1, 2026

(54) Dolly Clamp

(71) Applicant: QUANTA ASSOCIATES, L.P., Houston, TX (US)

(72) Inventors: Benjamin James Harvey, Cape Coral, FL (US); David Karl Wabnegger, La Grange, TX (US); Raymond Henry Jodoin, Ardrossan (CA); Daniel Neil O'Connell, Oliver (CA)

(21) Appl. No.: 19/577,004

(22) Filed: Mar. 24, 2026

Related U.S. Application Data
(60) Provisional application No. 63/777,322, filed on Mar. 25, 2025.

(51) Int. Cl. F16D 63/00; F16D 65/18; F16D 121/24; F16D 125/22

(52) U.S. Cl. CPC F16D 63/008; F16D 65/18; F16D 2121/24; F16D 2125/22

(57) ABSTRACT

A dolly clamp is adapted to mount onto a dolly having a frame suspending a sheave wheel. The dolly clamp includes an actuator adapted to mount, at a first end thereof, to the frame so as to extend, when actuated, along a translation trajectory relative to the frame. At least one die is mounted to a second end of the actuator. Each die has a linear groove disposed so as to engage a conductor in the sheave wheel. The linear groove in each die is maintained by the actuator in alignment with a corresponding annular groove on the corresponding sheave. Upon actuation the actuator clamps the die against the conductor or sub-conductor secures the conductor or sub-conductor in the sheave.

### FIELD

This disclosure relates to equipment used in stringing and maintaining power line conductors, and in particular to an improved dolly, traveler or stringing block, herein referred to collectively as a dolly, having a clamp to secure a conductor or conductors temporarily in position within the sheave or sheaves.

### BACKGROUND

Due to weather or other delays, sometimes a conductor has to be left in a dolly during stringing operations of the conductor or reconductoring. The manufacturers of a transmission conductor may recommend that the conductor not be allowed to rest in the dolly for more than 72 hours in order to avoid damage to the conductor. The damage may result from the conductor moving back and forth in the dolly sheave so as to compress the same short length of conductor repeatedly as the conductor moves back and forth over the sheave. Movement of the conductor in a dolly when left too long may also adversely affect the conductor sag. Vibration of the conductor may also cause damage to the outer strands of the conductor or to break.

During re-conductoring energized conductors are moved and relocated to temporary locations on support structures. Typically during this process the conductor is left clamped or clipped in or moved and re-clamped. To improve efficiency the conductor may be unclamped or unclipped and installed into a dolly while the conductor is energized to prevent having to revisit the structure again to unclamp and install the conductor into a dolly for stringing.

Temporarily securing the conductor in the sheave will improve efficiency and alleviate both adverse effects and potential damage being done to the conductor by leaving the conductor unsecured in the dolly sheave.

Hence it is an object to provide a conductor immobilizer and securement apparatus, such as a clamp, however actuated, for use on a dolly, and to provide a system including the dolly and clamp, or which include a plurality of clamping dollies which may be manually or remotely actuated.

### SUMMARY

A conductor immobilizer such as a dolly clamp, and a system including both the dolly and clamp, includes an attachment for a conductor stringing dolly that can temporarily secure the conductor in the sheave of the dolly. One such attachment provides for clamping the conductor in the sheave of the dolly by means of an actuator. The actuator may be for example a scissor jack mounted on or in the support frame of the dolly or other forms of actuators such as clamps actuated by levers which may be side mounted on or in the frame and are releasably securable when the clamp is in its clamped position. Such clamps may include so-called toggle clamps which are over-center self-locking, including horizontal toggle clamps. An example of a horizontal toggle clamp is the DeStaCo horizontal toggle clamp sold by Lee Valley Tools (item no. 88F0501), the fundamental mechanics of which may be adapted by those skilled in the art to provide a form of conductor clamp mechanism mountable on a dolly frame.

The dolly support frame rotatably supports the sheave in the dolly. Conventionally the frame may be u-shaped, where the axis of rotation of the sheave runs between the ends of a pair of arms on the u-shaped frame.

In the clamp embodiment, the clamp, and in particular the actuator, may for example be manually operated by a lineman or may be remotely operated by means of a motor operated by a lineman or workman located, for example, on the ground. Advantageously the clamp embodiment is coupled or otherwise mounted to or cooperating with the dolly so that the clamp is in cooperative engagement with a conductor resting in the sheave of the dolly.

In one embodiment, the clamp is mounted within the dolly support frame and includes the actuator, such as a scissor jack actuator or lever actuator, selectively pushing a die or other friction clamping pad or head (collectively referred to herein as a die) against a conductor or sub-conductor residing in the sheave. In other embodiments the dolly may have multiple, for example three, side-by-side sheaves to receive a corresponding number of sub-conductors in a bundle.

Employing a dolly clamp such as described herein may provide, without being required in preferred embodiments, the following potential advantages: to act as securement of conductors over other energized lines known as hot crossings or road/highway crossings, to prevent handling conductors more than once during stringing operations such as reconductoring is required, to secure energized phases, to remove the need to visit a structure to mark a conductor when performing clipping offsets using the remotely operated clamp lock down described herein, to provide interchangeable clamp dies so as to match the concave curved profile of the die to the diameter of the conductor and to the sheave groove profile, thereby improving the grip of the clamp die when clamped against the conductor, and, to provide a dolly clamp that is adaptable to, and may in some embodiments be retrofitted to, conventional dolly designs.

Further advantageously, embodiments may include, without being essential, one or more of the following features: cellular link, Bluetooth, or WIFI link, solar charging of a battery in or on, and cooperating with, a motorized embodiment of the clamp to allow for remote operation of the clamp for long periods without the need for otherwise recharging of the battery when the dolly clamp is installed and the dolly suspended in use or left for later use, remote operation for remotely controlling drive unit for actuating the clamp which may be a removeable remote electrical drive.

In further embodiments, not intended to be limiting:
(a) Although not illustrated herein, the clamp die may lock into the dolly sheave in the manner of a tooth on a gear engaging into a depression in the sheave, providing for locked alignment of the die with the sheave wheel to prevent any relative motion between the two while the die continues to apply pressure directly onto the clamped portion of the conductor. The clamp may include a sensor to read conductor travel speed, which, above a threshold conductor velocity over the sheave, triggers actuation of the clamp down onto the conductor to serve as a brake to slow and/or modulate the conductor velocity.
(b) The clamp may include a sensor to monitor vibration or other movement of the conductor, for example in a radial direction relative to the sheave (radial relative to the axis of rotation of the sheave wheel) to monitor if the conductor in the sheave or the dolly itself are running smoothly.
(c) A camera may be cooperatively mounted, and remotely accessed, for example a via a cell phone link, on the dolly or clamp for remote monitoring of the clamp, dolly or conductor clamped therein.
(d) Remote operation of the dolly clamp may be via a software application, for example on a so-called smart device such as a cell phone or tablet or on a laptop computer or other mobile computing device so that actuation of the clamp, engaging or releasing the conductor in the sheave, may be done from the mobile computing device.
(e) A software application for the mobile computing devices may be provided to remotely control individual clamping pressure in an array of multiple clamping dollies simultaneously to reduce strain on one or more conductor support structures on which the dollies are mounted by using stress distribution amongst the structures provided by selective and coordinated braking to slow and/or modulate the conductor travel speed in each of the clamping dollies in the array of clamping dollies.

In summary then, the present specification includes within its ambit a dolly clamp adapted to be mounted onto a dolly having a frame such as for example a u-shaped frame suspending a sheave wheel for rotation of the sheave wheel on the frame. For a u-shaped frame embodiment the sheave wheel may have an axis of rotation extending between ends of oppositely disposed arms of the frame. The arms of the frame extend from a vertex of the frame so as to form the u-shape of the frame. Other shaped frames may also work as would be known to one skilled in the art.

The dolly clamp may include:
(a) an actuator adapted to mount to a frame, wherein for a u-shaped frame a linear actuator may mount, at a first end thereof, to the vertex of the u-shaped frame so as to extend, when actuated, from the vertex along a linear translation trajectory substantially bisecting between the arms of the frame, and in other examples the actuator mounts in cooperation with its frame such as side-mounts on the frame,
(b) at least one die mounted to a second end of the actuator, opposite the first end of the actuator, so as to dispose oppositely to the actuator a linear groove in the at least one die,
wherein the linear groove in the at least one die is maintained by the actuator in alignment with a corresponding at least one annular groove on a corresponding sheave,
and wherein upon actuation the actuator is adapted to translate the at least one die along the translation trajectory into clamping engagement against a conductor or sub-conductors resting or otherwise temporarily residing in the corresponding groove of the at least one annular groove of the corresponding sheave.

The translation trajectory of the actuator may advantageously be linear, for example if the actuator is a linear actuator such as a jack or cylinder and radial to the axis of rotation of the sheave wheel, or may move in an arc, for example if the die is on a lever arm, so that only at the point of contact with the conductor is the trajectory of the die radial to the axis of rotation of the sheave wheel.

The actuator may be a scissor jack. In a scissor jack embodiment a jack screw such as a threaded rod is rotatably mounted within the jack so as to, when selectively rotated, selectively extend or retract the jack and the at least one die mounted thereon along the translation trajectory. The jack screw may be manually or otherwise mechanically rotated by a lineman located in proximity to the dolly.

In a multi sub-conductor bundle sheave configuration a platen may be mounted on the second end of the actuator and the at least one die is a corresponding plurality of dies mounted on the platen, on an opposite side of the platen relative to the actuator. In preferred and conventional embodiments of the dolly, the dolly is suspended on an insulator from the vertex of the u-shaped frame so that the arms of the frame hang downwards. Thus, in such embodiments, the actuator is mounted under the vertex of the frame for downward actuation between the arms of the frame, to thereby press the die or dies downwards to engage, clamp and secure the conductor or sub-conductors in the sheave or sheaves respectively.

Each die may be elongate and the linear groove in each die runs the length of the die and is sized so as to snugly receive the conductor or sub-conductor therein and therealong when each die clamps onto its corresponding conductor or sub-conductors in the groove or grooves of the sheave or sheaves.

In some embodiments the actuator may be a powered actuator which, instead of being manually motivated, is selectively actuated by a motive force of a prime mover mounted thereon or in cooperation therewith. For example, the prime mover may be an electric motor. Where the actuator is a scissor jack, the electric motor may be mounted on one end of the jack, or otherwise in cooperation with the jack, so as to rotate the jack screw within the jack to selectively extend or retract the jack and the at least one die mounted thereon.

A set of dies may be provided, where the dies in the set are interchangeable on the end of the actuator, and where the dies in the set have their linear grooves of different sizes to accommodate different sized conductors or sub-conductors and different sized grooves in the sheaves.

Each die has a first or upper surface mounted to the second or lower end of the actuator. Each die also has an opposite second or lower surface in which the dies' linear groove is formed. The second or lower surface of the die is advantageously concave when viewed in an elevation view (eg: the side elevation view of FIG. 2) to substantially follow a curvature of the groove in the corresponding sheave. The die may be of resilient material or may be lined with resilient material to inhibit damage to the conductor's exterior strands, assist in reducing conductor slippage, and may have extended longitudinal ends which are resilient to assist in absorbing or dampening vibrations from the conductor. The extended longitudinal ends of the die may have added mass, so as to for example form the shape of a dog bone with the die, also to assist in absorbing or dampening conductor vibration.

A further system may be provided in which a clamping pressure exerted by a dolly clamp may be selectively remotely adjusted and modulated so as to act as a brake on a moving conductor rather than only an immobilizer. An array of such selectively pressure-modulated clamping dollies may act in a cooperating system, for example based on sensor feedback from a particular conductor supporting structure or set of structures, to distribute loading from that particular structure amongst the set of structures on which the conductor is suspended to alleviate possible overloading on that particular structure.

### BRIEF DESCRIPTION OF THE DRAWINGS

FIG. 1 is, in left side perspective view, one embodiment of the dolly clamp according to the present disclosure mounted in a dolly.

FIG. 1A is, in front side elevation view, the dolly clamp and dolly of FIG. 1, with the conductor shown in cross section.

FIG. 1B is an enlarged view of the view of FIG. 1A.

FIG. 2 is, in left side elevation view, the dolly clamp of FIG. 1.

FIG. 3 is, in partially cutaway right rear side elevation view skewed into a slightly perspective view, the dolly clamp of FIG. 1.

FIG. 4 is, in right side perspective view, the dolly clamp of FIG. 1.

FIG. 5 is, in right side view, the dolly clamp of FIG. 1.

FIG. 6 is the view of FIG. 1 with an electric motor mounted on the jack.

FIG. 7 is, in partially cutaway rear side elevation view skewed into a slightly perspective view, the dolly clamp of FIG. 6.

FIG. 8 is, in rear right side perspective view, the motorized dolly clamp of FIG. 6.

FIG. 9 is, in upper rear side perspective view the dolly clamp of FIG. 8.

FIG. 10 is, in rear left side perspective view, a three bundle variant of the dolly clamp of FIG. 1.

FIG. 11 is, in partially cutaway front side elevation view, the dolly clamp of FIG. 10.

### DETAILED DESCRIPTION

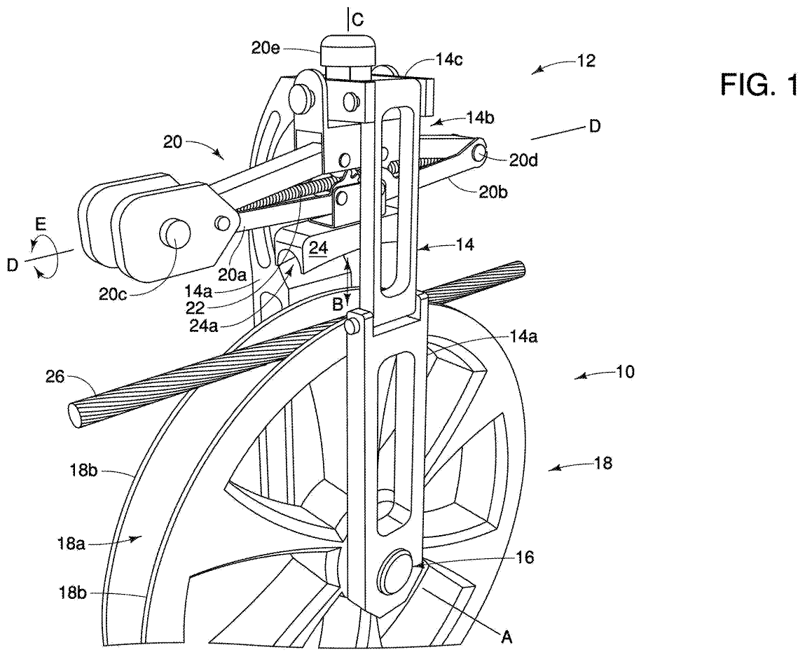

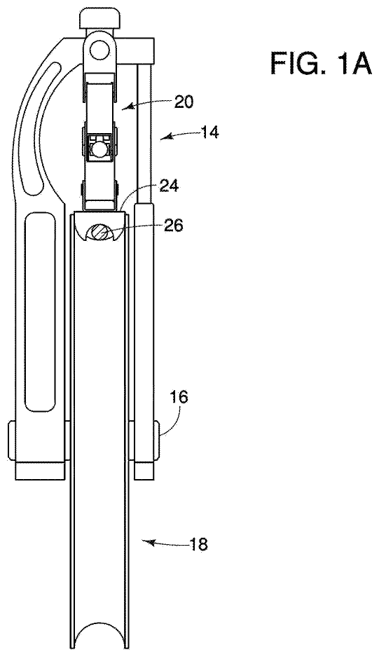

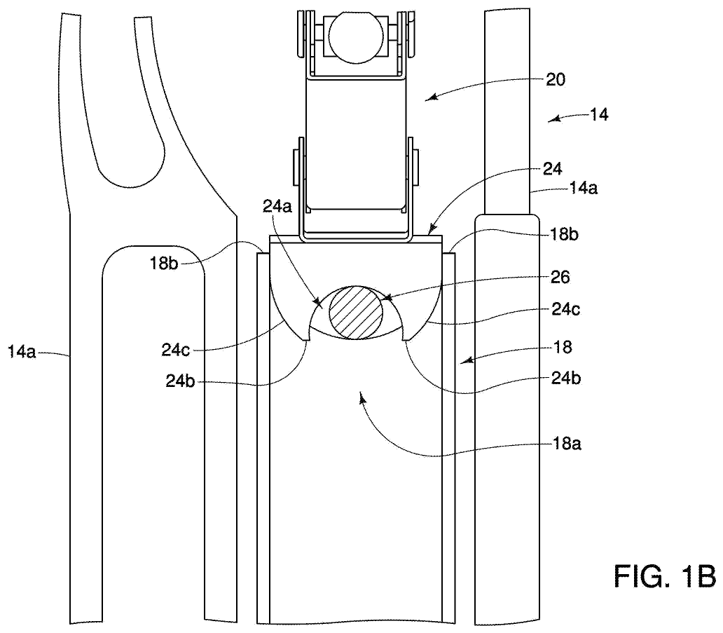

As seen in the accompanying drawing figures wherein like reference numerals indicate like parts in each view, and as seen in FIG. 1, dolly 10 includes a dolly clamp, such as clamp 12, mounted thereon.

What follows is a description of an embodiment, without intending to be limiting, of a scissor-link jack actuated clamp embodiment of a dolly clamp. In the illustrated example, and as seen in FIG. s 1-11, a u-shaped frame 14 and 14′ has a pair of parallel arms 14a. Axle 16 of sheave 18 and sheaves 18′ is mounted across the distal ends of arms 14a, so as to be perpendicular thereto, along the axis of rotation A of sheave as shown in FIG. s 1, 4, and 10.

A scissor-link jack 20 is mounted within the channel 14b formed between arms 14a to the vertex 14c of frame 14 by means of a bolt (not shown) and ball coupler arrangement 20e which connects the dolly to an insulator mounted to a support structure. Scissor-link jack 20 is mounted at its upper end to the underside of vertex 14c so as to suspend jack 20 downwardly within channel 14b. Jack 20 may have scissor linkages 20a and 20b which, in a conventional manner, expand or collapse the linkages upon the turning of a threaded rod 22 threadably journalled for example in threaded apertures (not shown) in the end pins 20c and 20d of jack 20.

The expanding and collapsing of the scissor linkages 20a and 20b moves conductor clamp die 24 vertically down and up, respectively, in direction B. Translation of die 24 in direction B engages die 24 downwardly to clamp conductor 26 or sub-conductors 26′ or upwardly to release conductor 26 or sub-conductors 26′ from the clamp. For preferred clamping effectiveness, direction B is along a radial axis C which lies in a plane, orthogonal to axis of rotation A, which contains sheave 18 and bisects between arms 14a of u-shaped frame 14. Other clamping orientations may also work, but in Applicant's view, clamping is best achieved by applying the clamping force of die 24 in direction B along radial axis C onto conductor 26, where conductor 26 passes over sheave 18 while retained in the annular groove 18a of the sheave.

Die 24 has a linear groove 24a sized to conformally mate down onto conductor 26. Die 24 may form one of a set of dies 24 each having different sized grooves 24a so as to accommodate conductors or sub-conductors having different diameters. For smaller diameter conductors, the correspondingly sized die 24 may be small enough so that the lower edges 24b of the die fit within the ridges 18b of groove 18a to allow die 24 to lower enough to engage both conductor 26 snugly within groove 24a of die 24 and the lower edges 24b, advantageously conformally curved in cross section such as seen in FIG. 1B where the curved sides 24c of die 24 conformally mate into groove 18a of sheave so as to match the cross sectional curved profile of groove 18a.

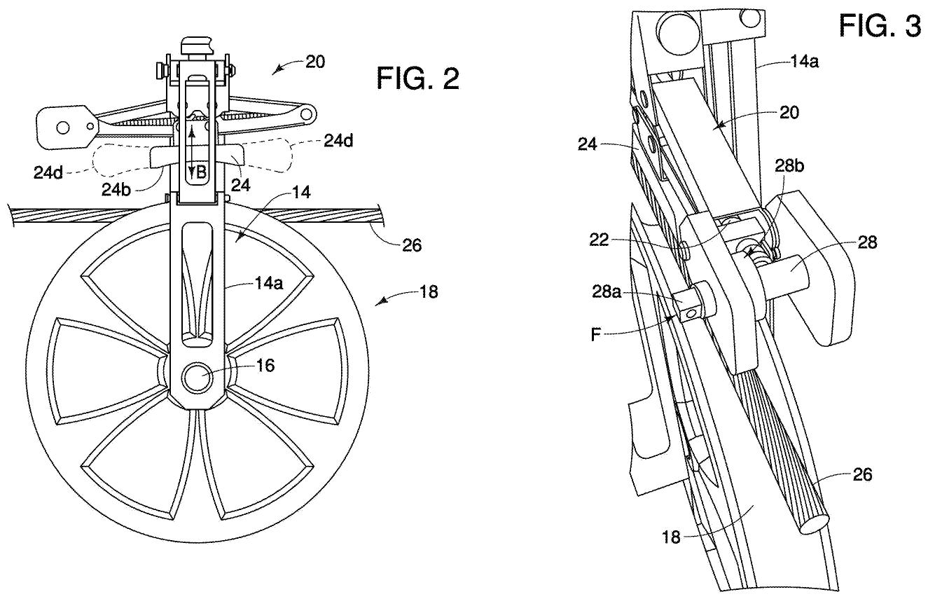

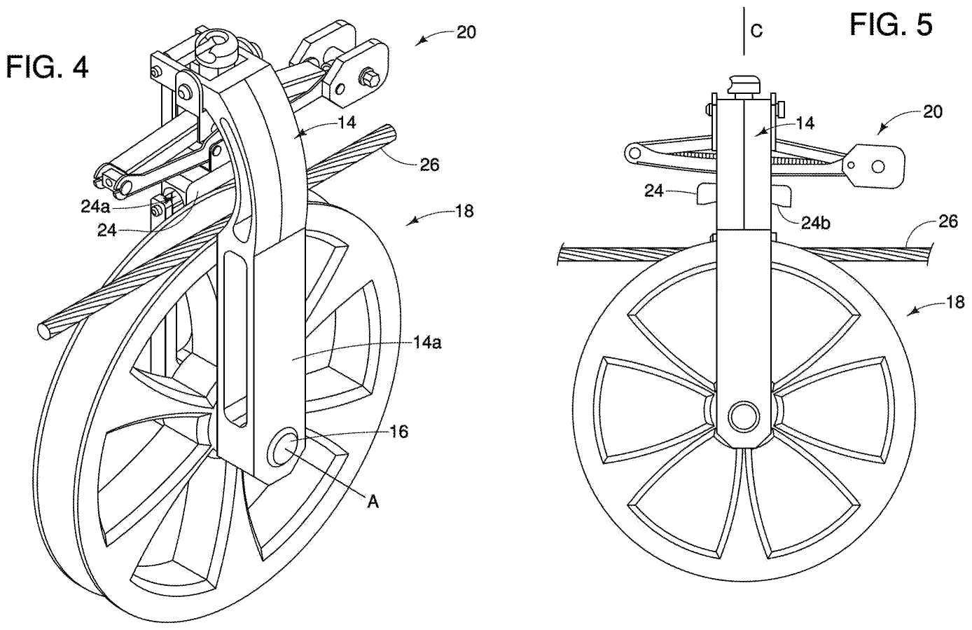

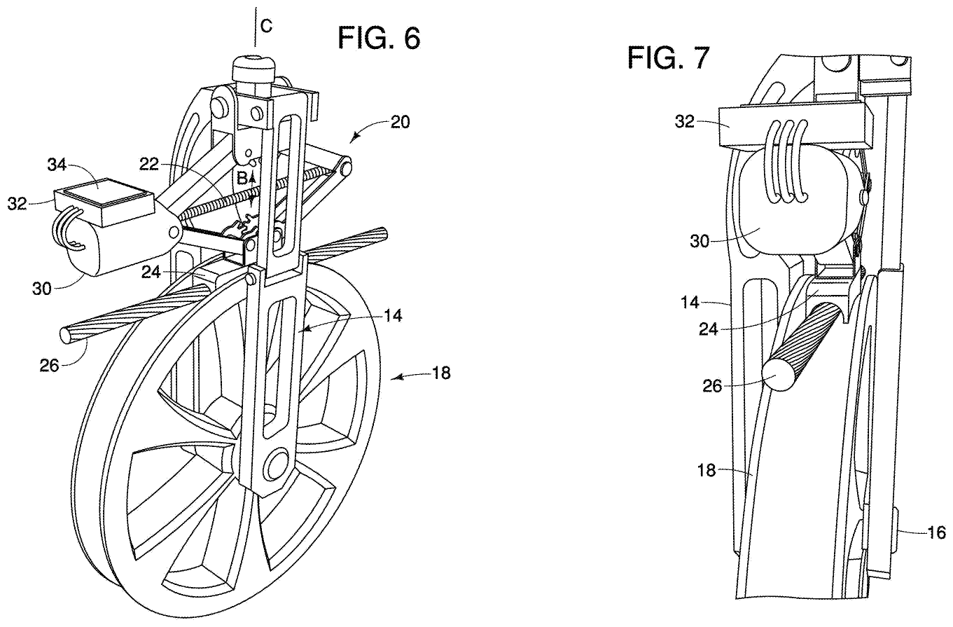

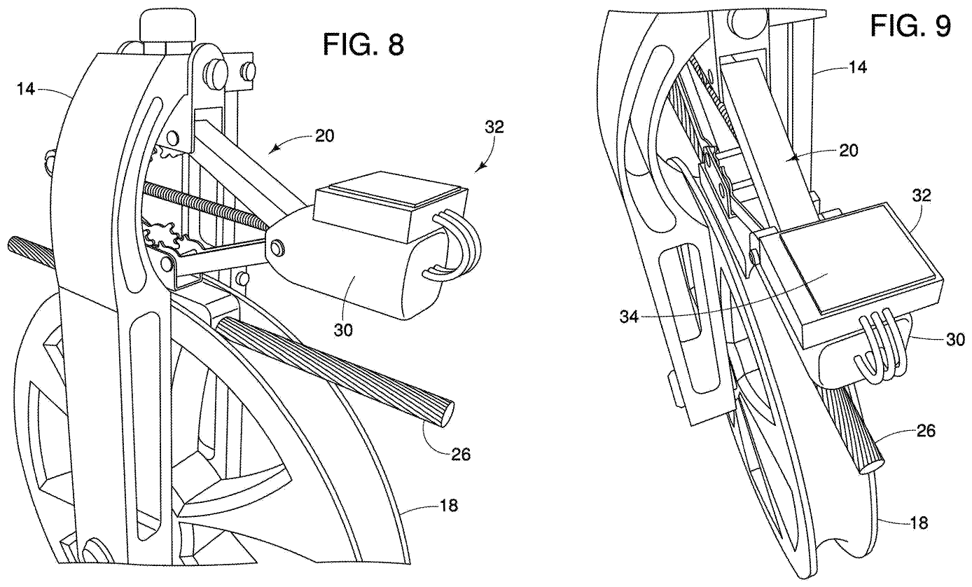

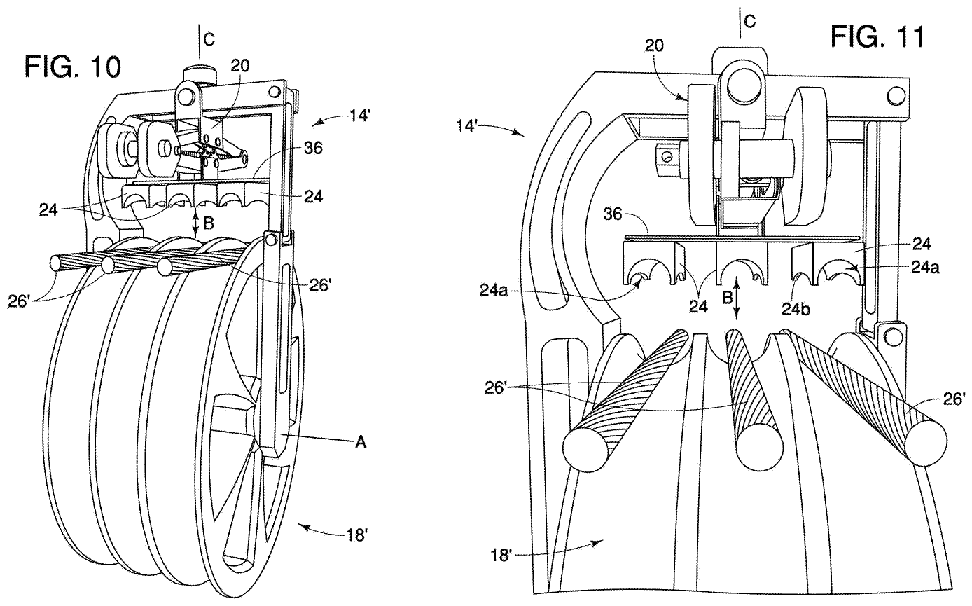

In one embodiment of die 24, lower edges 24b of die 24 are concave, as better seen in FIG. 2, so as to follow the curvature of groove 18a of sheave 18. In a further embodiment, shown in dotted outline, die 24 is lengthened by lengthening portions 24d on each end of die 24 beyond that illustrated for example in FIG. 2, and advantageously made, or at least the lengthened end portions are made resilient so that, as the die 24 is held clamped down onto conductor 26, the lengthened ends of the die serve to dampen the vibration in the conductor. The end portions 24d may be bulbous (shown diagrammatically in dotted outline in FIG. 2) so that the die resembles a “dog bone” shape, whereby the mass of each end of the die is increased to increase vibration dampening of vibration in the conductor.

In the manually operated embodiment of FIG. s 1-5, a lineman (not shown), for example using a hot stick (not shown) manually rotates threaded rod 22 about its axis of rotation D in direction E to either raise or lower die 24 in direction B. As seen in the embodiment of FIG. 3, and without intending to be limiting, bolt 28 has a bolt head 28a. Bolt head 28a may be engaged, for example, by an impact gun, ratchet or wrench on the end of a hot stick (not shown) which has been moved by a lineman into position, for example in direction F (FIG. 3). Gearing 28b converts rotary motion of bolt 28 into the rotary motion of threaded rod 22, which drives actuation of scissor linkages 20a and 20b.

In the motorized embodiment of FIG. s 6-9, and again without intending to be limiting, an electric motor 30 is mounted over and engaged so as to drive bolt 28, or, in lieu of engaging bolt 28, directly engages rod 22 with internal gearing (not shown), as would be known to one skilled in the art, so as to selectively rotate rod 22. Electric motor 30 may advantageously be remotely wirelessly activated to actuate clamping and unclamping of conductor 26. Motor 30 may be powered by a battery 32, which may itself be recharged by solar panel 34.

In the example of a three sub-conductor bundle embodiment of FIG. s 10 and 11, sheave 18 is replaced with a three side-by-side sheave wheel 18′ rotatably mounted within a correspondingly widened u-shaped frame 14′. Three sub-conductors 26′ may be simultaneously supported by sheave wheel 18′. A platen 36 is rigidly mounted to the underside of jack 20. Three parallel dies 24 are mounted, side-by-side, to the underside of platen 36, so that each die 24 is aligned above a corresponding sheave groove in sheave wheel 18′ so as to engage their corresponding sub-conductor 26′ when lowered by jack 20 into engagement clamping and securing the sub-conductors 26'.

The sheaves 18 and 18′ and/or the grooves 18a in the sheaves 18 and 18′ may be electrically conductive or may be dielectric. The dies 24 may be electrically conductive or may be dielectric.

The foregoing descriptions have been presented for purposes of illustration. They are not exhaustive and are not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

It should be noted that, the relational terms herein such as “first” and “second” are used only to differentiate an entity or operation from another entity or operation, and do not require or imply any actual relationship or sequence between these entities or operations. These terms are used to distinguish one element from another. For example, a first element could be termed a second element, and, similarly, a second element could be termed a first element, without departing from the scope of the embodiments.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the terms “and/or” and “or” encompass all possible combinations, except where infeasible. For example, if it is stated that a system may include A or B, then, unless specifically stated otherwise or infeasible, the system may include A, or B, or A and B. As a second example, if it is stated that a system may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A dolly clamp adapted to mount onto a dolly having a frame suspending a sheave wheel for rotation of the sheave wheel relative to the frame on a corresponding axis of rotation, the dolly clamp comprising:
an actuator adapted to mount, at a first end thereof, to the frame so as to translate, when actuated, at least one die mounted to a second end of the actuator along a translation trajectory so as to maintain a linear groove in the at least one die in alignment with a corresponding at least one annular groove on a corresponding sheave,
and wherein upon actuation the actuator is adapted to translate the at least one die along the translation trajectory into clamping engagement against a conductor or sub-conductor resting in the corresponding groove of the at least one annular groove of the corresponding sheave.

2. The dolly clamp of claim 1 wherein the actuator is a linear actuator.

3. The dolly clamp of claim 2 wherein the actuator is a scissor jack.

4. The dolly clamp of claim 1 wherein a platen is mounted on the second end of the actuator and the at least one die is mounted on the platen, on opposite sides of the platen to the actuator.

5. The dolly clamp of claim 1 wherein each die of the at least one die is elongate and the linear groove runs the length of the die and is sized so as to snugly receive the conductor or sub-conductor therein and therealong when each die clamps onto its corresponding conductor or sub-conductor in the sheave groove.

6. The dolly clamp of claim 1 wherein the translation trajectory is linear and radial to the axis of rotation of the sheave wheel is at least a point of contact of the at least one die with the conductor.

7. The dolly clamp of claim 1 wherein in the actuator is a powered actuator which is selectively actuated by a motive force of a prime mover mounted so as to cooperate with the actuator.

8. The dolly clamp of claim 7 wherein the prime mover is an electric motor.

9. The dolly clamp of claim 8 wherein the actuator is a scissor jack and the electric motor is mounted on one end of the jack so as to rotate a jack screw within the jack to thereby selectively extend or retract the jack and the at least one die mounted thereon.

10. The dolly clamp of claim 3 wherein a jack screw is rotatably mounted within the jack so as to, when selectively rotated, selectively extend or retract the jack and the at least one die mounted thereon, and wherein the jack screw is manually mechanically rotated by a lineman located in proximity to the dolly.

11. The dolly clamp of claim 1 wherein the at least one die is one of a set of dies, and wherein the dies in the set of are interchangeable on the second end of the actuator, and where the dies in the set of dies have their linear grooves of different sizes to accommodate different sized conductors or sub-conductors.

12. The dolly clamp of claim 5 wherein each die has a first surface mounted to the second end of the actuator and an opposite second surface in which the linear groove is formed, and wherein the second surface is concave to substantially follow a curvature of the groove in the corresponding sheave.

13. The dolly clamp of claim 12 wherein each die has an extended length portion on each end of the die, and wherein at least the extended length portions are resilient to attenuate vibration in the conductor.

14. A dolly clamp system including an array of the clamping dollies having the dolly clamps of claim 1, the system comprising software to remotely control individual clamping pressure from each of the dolly clamps in each of the clamping dollies in the array of clamping dollies simultaneously to reduce strain on one or more conductor support structures on which the clamping dollies are mounted by a stress distribution method amongst the structures provided by selective and coordinated braking of the conductor in each of the clamping dollies in the array of clamping dollies.
